(19) United States
(12) Patent Application Publication
(10) Pub. No.: US 2011/0030414 A1
(43) Pub. Date: Feb. 10, 2011

(54) AIR CONDITIONING SYSTEMS WITH OVERSPED INDUCTION MOTORS

(75) Inventors: Ty Allan Newell, Urbana, IL (US); Benjamin Eric Newell, Urbana, IL (US); Alexander Yemma Long, Champaign, IL (US)

Correspondence Address: FLETCHER YODER (ILLINOIS TOOL WORKS INC.), P.O. BOX 692289, HOUSTON, TX, 77269-2289, US

(73) Assignee: Hobart Brothers Company, Troy, OH (US)

(21) Appl. No.: 12/819,793

(22) Filed: Jun. 21, 2010

Related U.S. Application Data
(60) Provisional application No. 61/232,258, filed on Aug. 7, 2009.

(51) Int. Cl. F25D 17/06; H02P 27/04; F04B 35/04

(52) U.S. Cl. 62/426; 318/808; 417/410.1

(57) ABSTRACT

Air conditioning systems including a refrigeration circuit having at least one fan or blower are provided. The air conditioning systems also include a multi-voltage induction motor coupled to the fan/blower. The multi-voltage induction motor includes motor windings adapted for use when the motor windings are wired in a first voltage wiring configuration and a second voltage wiring configuration, the second voltage being greater than the first voltage. The multi-voltage induction motor may be wired in the first voltage wiring configuration, and a variable frequency drive may be adapted to maintain an operating voltage to frequency ratio of the multi-voltage induction motor at approximately a voltage to frequency design ratio of the multi-voltage induction motor. Also provided are power conductors adapted to transmit power to the variable frequency drive at a voltage approximately equal to the second voltage for operation of the multi-voltage induction motor.

### CROSS REFERENCE TO RELATED APPLICATIONS

This application is a Non-Provisional patent application of U.S. Provisional Patent Application No. 61/232,258, entitled “Blower/Fan Over-Speed”, filed Aug. 7, 2009, which is herein incorporated by reference.

### BACKGROUND

The invention relates generally to induction motors, and, more particularly, to multi-voltage induction motors for powering of fans and/or blowers.

Induction motors are utilized in a variety of industries and applications, such as ground support equipment units that support grounded aircrafts. Such motors typically include stator windings in a core disposed around a rotor and capable of creating a rotating magnetic field that induces rotor rotation. As such, induction motors may not supply a current directly to the rotor to generate rotor rotation; power is supplied to the rotor via electromagnetic induction. The foregoing features of induction motors may offer advantages over synchronous motors, such as the absence of brushes, the ability to exhibit close control over the speed of the motor, and so forth.

Unfortunately, while induction motors offer many advantages, such motors are also associated with drawbacks, which may inhibit or prevent their use in some applications. For example, induction motors apply torque based on a ratio of the voltage to the frequency and are typically associated with preset current and voltage ratings. Such features may limit the operational speed and power capabilities of induction motors, possibly resulting in the need for bulky system components, which may be heavy and costly. Further, induction motors sometimes may be configured to be wired either in a low voltage configuration and operated with a low voltage source or in a high voltage configuration and operated with a high voltage source. Such a feature may limit the power output achievable with the induction motor. Accordingly, there exists a need for systems and devices that address such drawbacks with current induction motor operation.

### BRIEF DESCRIPTION

In an exemplary embodiment, an air conditioning system includes a refrigeration circuit having at least one fan or blower. The air conditioning system also includes a multi-voltage induction motor coupled to the at least one fan or blower and including motor windings adapted for use when the motor windings are wired in a first voltage wiring configuration and a second voltage wiring configuration, the second voltage being greater than the first voltage. The multi-voltage induction motor is wired in the first voltage wiring configuration. The air conditioning system also includes a variable frequency drive coupled to the multi-voltage induction motor and adapted to maintain an operating voltage to frequency ratio of the multi-voltage induction motor at approximately a voltage to frequency design ratio of the multi-voltage induction motor. The air conditioning system also includes power conductors adapted to transmit power to the variable frequency drive at a voltage approximately equal to the second voltage for operation of the multi-voltage induction motor wired in the first voltage wiring configuration.

In another embodiment, an air conditioning system includes a refrigeration circuit having at least one fan or blower. The air conditioning system also includes a three phase alternating current (AC) induction motor coupled to the at least one fan or blower and including windings adapted to be interconnected in a first voltage configuration and a second voltage configuration, the second voltage being greater than the first voltage, wherein the windings are interconnected in the first voltage configuration. The air conditioning system also includes three phase power conductors adapted to provide an output voltage equal to approximately the second voltage and a variable frequency drive adapted to receive power from the three phase power conductors and to control operation of the three phase AC induction motor.

In another embodiment, an air conditioning system includes a refrigeration circuit having at least one fan or blower. The air conditioning system also includes a multi-voltage induction motor coupled to the at least one fan or blower and including windings adapted to be wired in a first voltage configuration and a second voltage configuration, the second voltage being greater than the first voltage, wherein the windings are wired in the first voltage configuration. The air conditioning system also includes a variable frequency drive coupled to the multi-voltage induction motor and adapted to increase an operating speed of the multi-voltage induction motor to a level exceeding a rated speed while maintaining a rated voltage to frequency ratio of the multi-voltage induction motor. The air conditioning system also includes power conductors adapted to provide the variable frequency drive an input voltage equal to approximately the second voltage for operation of the multi-voltage induction motor.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an aircraft coupled to an exemplary air delivery system including an oversped induction motor via an air hose assembly in accordance with aspects of the present invention;

FIG. 2 is a schematic illustrating an exemplary refrigeration system including a variety of multi-voltage induction motors that may be utilized in the ground support equipment unit of FIG. 1 in accordance with aspects of the present invention;

FIG. 3 is a pressure-flow graph illustrating a duct system flow curve, a lower speed blower curve, and a higher speed blower curve in accordance with aspects of the present invention; and

FIG. 4 is a graph illustrating exemplary plots of oversped torque, traditional torque, oversped horsepower, and traditional horsepower in accordance with aspects of the present invention.

### DETAILED DESCRIPTION

As described in detail below, embodiments are provided of multi-voltage induction motors wired in a lower voltage configuration but configured for operation at a higher supply voltage. As such, the multi-voltage induction motors described herein may be “oversped” for blower and fan operation via coupling of the multi-voltage induction motors to a variable frequency drive (VFD) configured to receive power from one or more power conductors. Overspeeding of the multi-voltage induction motors in this manner may facilitate the production of a higher power output from the blower or fan (for improved air displacement, efficiency, and cooling) as compared to a multi-voltage motor wired in the lower voltage configuration and configured for operation at a lower supply voltage. The foregoing feature may have the effect of reducing the size, weight, and expense of multi-voltage induction motors chosen for a variety of applications. For example, by overspeeding the multi-voltage induction motors associated with refrigeration cycles located on aircraft ground support equipment, the size and weight of such ground support equipment may be reduced compared to existing systems without compromising the desired output. However, although the multi-voltage induction motors shown herein are illustrated and discussed in the context of aircraft ground support equipment, it should be noted that embodiments of the oversped motors described herein may be used in any of a variety of contexts for any of a variety of suitable applications.

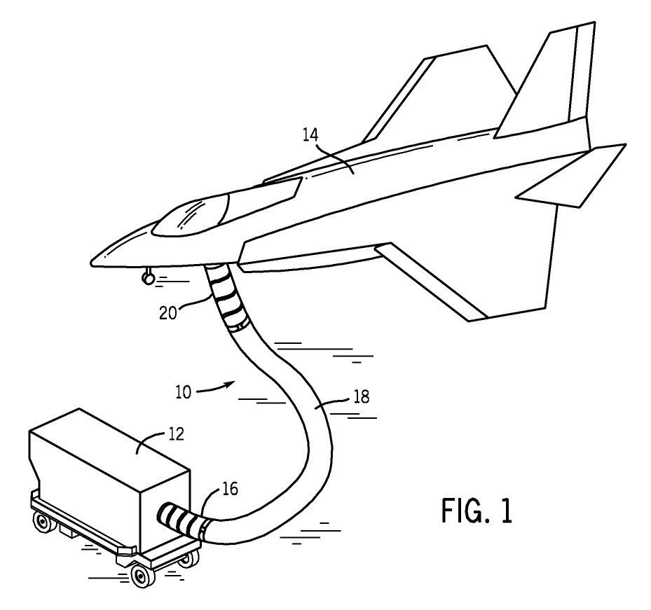

Turning now to the drawings, FIG. 1 illustrates a preconditioned air hose assembly 10 that is configured to couple an air delivery system 12 to an aircraft 14. In the illustrated embodiment, the air hose assembly 10 includes a first connector 16, which connects the air delivery system 12 to a hose portion 18 of the air hose assembly 10. The illustrated air hose assembly 10 also includes a second connector 20, which connects the aircraft 14 to the hose portion 18 of the air hose assembly 10. The air hose assembly 10 delivers conditioned air to the aircraft 14 to alleviate the need to use the air conditioning system of the aircraft itself while the aircraft 14 is parked, or to supplement any on-board air conditioning that may be inadequate for the needed air conditioning when the aircraft is on the ground. As such, the conditioned air may be cooled air, heated air, filtered air, or air conditioned to any other suitable state. Such preconditioned air may be beneficial for temperature regulation of electronics and/or aircraft personnel while the aircraft 14 is on the ground.

In the illustrated embodiment, the aircraft 14 is a high performance military aircraft 14. However, in other embodiments, the aircraft 14 may be any aircraft, such as a commercial passenger airplane or a private aircraft. Furthermore, aircraft 14 is illustrated as it may be parked on the ground, such as at a terminal or other facility. The ground is generally a tarmac, runway, or hangar floor, but could be any surface on which an aircraft is parked (e.g., the deck or hold of a ship). The air hose assembly 10 is typically moved out of the way of the aircraft when the aircraft is in motion, such as when it taxies to and from a terminal. When aircraft 14 is parked, air hose assembly 10 is moved into proximity and connected to aircraft 14, thus connecting the air delivery system 12 and aircraft 14. Before aircraft 14 begins moving, air hose assembly 10 is detached from aircraft 14 and moved away so that it is not in the path of aircraft 14 or so that it can be used to couple air delivery system 12 to another aircraft.

The air delivery system 12 may, for example, be a mobile ground support unit, as illustrated in FIG. 1. Alternatively, the air delivery system 12 may include equipment that is attached to a passenger bridge or to a fixed location, such as the terminal building. Furthermore, the air delivery system 12 may include one of more multi-voltage induction motors that are configured to be oversped during operation. That is, the air delivery system 12 may include induction motors used to power fans, blowers, and so forth, located within the air delivery system 12. Such multi-voltage induction motors may be configured to be wired in at least two configurations, specifically, a first wiring configuration and a second wiring configuration, corresponding respectively to a first voltage and a second voltage higher than the first voltage. In accordance with the present techniques, at least one of the multi-voltage induction motors is wired in the first wiring configuration but operated with the second higher supply voltage.

For example, in one embodiment, the multi-voltage induction motor may be configurable for 440V supplied to 220V wiring in the oversped configuration. Such an embodiment may increase the power capability of the induction motor as compared to an induction motor with 220V supplied to 220V wiring. The foregoing advantage may be achieved because the oversped induction motor may be associated with a variable frequency drive (VFD) that receives power from one or more power conductors and allows the frequency of the power supplied to the motor to be increased above or below the rated grid or power supply frequency (e.g., 60 Hz in North America), thereby regulating the voltage and facilitating proper motor function.

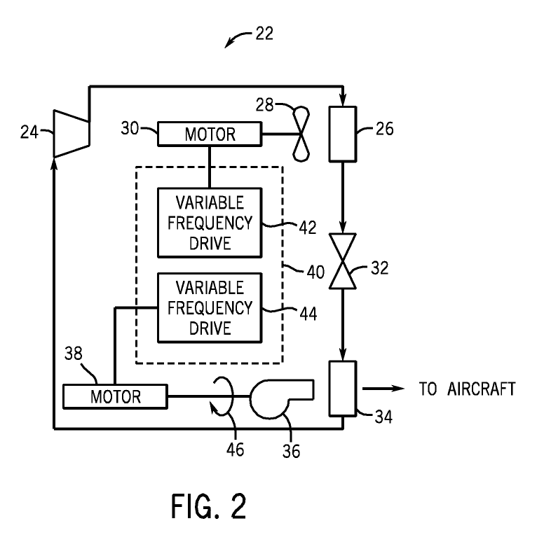

FIG. 2 is a schematic illustrating an exemplary refrigeration system 22 including a variety of multi-voltage induction motors that may be utilized in the ground support equipment unit 12 of FIG. 1. Specifically, in the embodiment shown, the refrigeration system 22 utilizes a vapor-compression cycle to generate the conditioned air. However, it should be noted that the refrigeration system 22 may employ any of a variety of suitable refrigeration cycles or techniques that are well known in the art to generate conditioned air. In the illustrated embodiment, the refrigeration system 22 includes a compressor 24, a condenser 26, a condenser fan 28, a motor 30, an expansion valve 32, an evaporator 34, a blower 36, a motor 38 and a variable frequency drive 40, interconnected to carry out a refrigeration cycle. The VFD includes a first variable frequency drive 42 configured to receive transmitted power from one or more power conductors and to regulate the motor 30 and a second variable frequency drive 44 configured to receive transmitted power from the one or more power conductors and to regulate the motor 38. As will be appreciated by those skilled in the art, the drives may include various circuit topologies known in the art, such as inverters, converters, and so forth, capable of producing a desired output frequency that, in turn, produces a desired rotational speed of the motors.

During operation, a refrigerant flows through the refrigeration system 22, which produces conditioned air that is expelled to the aircraft. For example, one exemplary refrigerant path is shown by the arrows in FIG. 1. In such a path, the vaporized refrigerant enters the compressor 24 where it is compressed at generally constant entropy to form a compressed vaporized refrigerant. The resulting refrigerant enters the condenser 26, which removes heat and condenses the vaporized refrigerant into a liquid. The liquid refrigerant then enters the expansion valve 32, which decreases the pressure of the liquid refrigerant. The refrigerant then flows through coils of the evaporator 34. While flowing through the evaporator 34, the refrigerant is vaporized, absorbing heat due to the latent heat of vaporization, and cools the ambient air moved over the evaporator coils by the blower 36. The vaporized refrigerant exits the evaporator 34 and enters the compressor 24 to continue the cycle.

The illustrated refrigeration system 22 relies on the fan 28 to blow air away from the condenser 26 for heat rejection during operation. Accordingly, the fan 28 is coupled to the multi-voltage induction motor 30, which drives its operation. The motor 30 is connected to the first variable frequency drive 42. The first variable frequency drive 42 controls the frequency of the high voltage power supplied to the multi-voltage induction motor 30. As such, the first VFD 42 allows the motor 30 to be wired in the lower voltage configuration but to receive the higher voltage supply. That is, in the illustrated embodiment, by overspeeding the motor 30, the size and weight of the motor 30 may be reduced as compared to traditional systems that match the supply voltage with the wiring configuration.

Similarly, the illustrated refrigeration system 22 also relies on the multi-voltage induction motor 38 to drive the operation of the blower 36, as indicated by arrow 46. As before, the motor 38 is coupled to the second frequency drive 44, which allows the motor 38 to be over-sped during operation. That is, the multi-voltage motor 38 may be wired for a lower voltage but operated with a higher supply voltage to ensure a high power output while reducing the size and weight of the motor as compared to traditional designs in which the wiring configuration matches the supply voltage level.

It should be noted that although in the illustrated embodiment, the variable frequency drive 40 includes two VFDs, in other embodiments, the VFD 40 may include any suitable number of VFDs that may be coupled to any number of multi-voltage over-sped motors. As such, in further embodiments, the refrigeration system 22 may include more or fewer motors than illustrated in FIG. 2 that may drive fans, blowers, or any other components of the refrigeration system 22. For example, an additional multi-voltage induction motor may be coupled to an additional fan or blower configured to direct ambient air over an intercooler of the blower 36. Indeed, any number of multi-voltage induction motors may be over-sped and utilized in the refrigeration system 22.

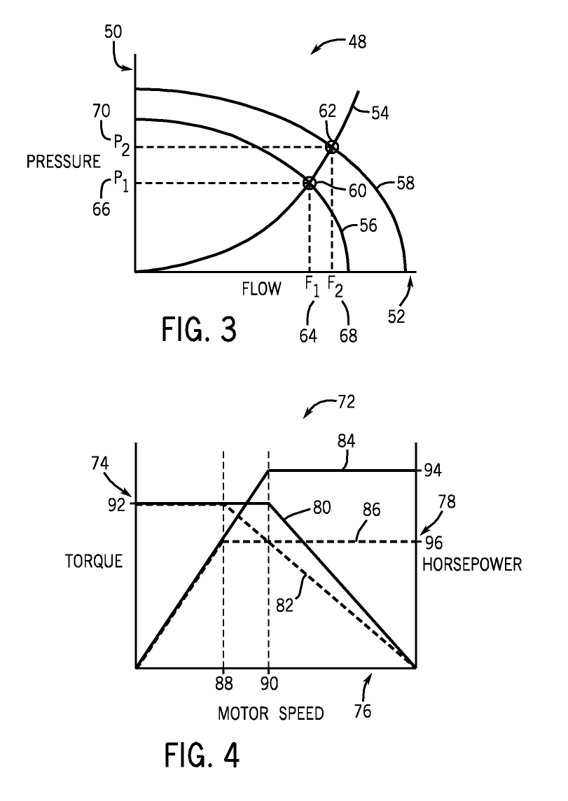

FIG. 3 is a pressure-flow graph 48 illustrating exemplary effects of overspeeding the multi-voltage induction motors described herein. The graph 48 includes a pressure axis 50 and a flow axis 52. The graph 48 also includes a duct system flow curve 54, a lower speed blower curve 56, and a higher speed blower curve 58. The graph 48 further includes a rated operating point 60 and an oversped operating point 62. That is, the lower speed blower curve 56 reflects operation of the blower when a multi-voltage induction motor is wired in a low voltage configuration and operated with a low voltage supply voltage; the induction motor is not oversped. The higher speed blower curve 58 reflects operation of the blower when the multi-voltage induction motor is wired in the low voltage configuration but operated with the higher supply voltage; the induction motor is oversped. As such, the higher speed blower curve 58 demonstrates exemplary effects that may be achieved by overspeeding the multi-voltage induction motor in some embodiments.

As illustrated, during use, the operating points of the higher speed blower and the lower speed blower are determined by the intersection of the duct system flow curve 54 with the high speed blower curve 58 and the lower speed blower curve 56. That is, in the illustrated example, the lower speed blower curve 56 and the duct system flow curve 54 intersect at operating point 60. Furthermore, the higher speed blower curve 58 and the duct system flow curve 54 intersect at operating point 62. As such, in the illustrated embodiment, advantages may be obtained by operating at the operating point 62 of the higher speed blower rather than operating at the operating point 60 of the lower speed blower. For example, operation at point 60 results in a first flow level 64 and a first pressure level 66, which are lower than a second flow level 68 and a second pressure level 70 that are obtained by operating at the second operating point 62. As such, operation along the higher speed blower curve 58 may achieve higher flow levels and higher pressure levels that operation along the lower speed blower curve 56. That is, by overspeeding the multi-voltage induction motor, higher flows and pressures may be obtained from the blower or fan during operation.

FIG. 4 is a graph 72 illustrating exemplary schematic plots comparing oversped induction motor characteristics with those of a traditional induction motor. Specifically, the graph 72 includes a torque axis 74, a motor speed axis 76, a horsepower axis 78, an oversped torque plot 80, a traditional torque plot 82, an oversped horsepower plot 84, and a traditional horsepower plot 86. The oversped torque plot 80 represents exemplary torque characteristics generated with a motor wired in a low voltage configuration but operated with a high voltage power source. The traditional torque plot 82 represents exemplary torque characteristics generated with a motor wired in a high voltage configuration and operated with a high voltage power source. Likewise, the oversped horsepower plot 84 represents exemplary horsepower characteristics generated with a motor wired in a low voltage configuration but operated with a high voltage power source. The traditional horsepower plot represents exemplary horsepower characteristics generated with a motor wired in a high voltage configuration and operated with a high voltage power source.

As illustrated, the traditional torque plot 82 falls off at a first speed 88, and the oversped torque plot 80 does not fall off until a second speed 90 higher than the first speed 88. As such, the oversped motor maintains torque level 92 to the higher speed 90 than the traditional motor, which maintains torque level 92 only until the lower speed 88. In some embodiments, such a feature of the oversped motor may enable the oversped motor to achieve a higher horsepower output 94 as compared to the traditional motor horsepower output 96. That is, while the traditional horsepower plot 86 levels off at the lower motor speed 88, the oversped horsepower plot 84 increases until leveling off at the higher motor speed 90. Since the oversped motor continues to increase horsepower output until the higher motor speed 90, the oversped motor may be capable of producing the higher horsepower output 94. Accordingly, embodiments of the presently disclosed oversped induction motors may offer distinct advantages over traditional systems, which are wired in a high voltage configuration and operated with a high voltage power source.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An air conditioning system, comprising:
a refrigeration circuit having at least one fan or blower;
a multi-voltage induction motor coupled to the at least one fan or blower and comprising motor windings configured for use when the motor windings are wired in a first voltage wiring configuration and a second voltage wiring configuration, the second voltage being greater than the first voltage, wherein the multi-voltage induction motor is wired in the first voltage wiring configuration;
a variable frequency drive coupled to the multi-voltage induction motor and configured to maintain an operating voltage to frequency ratio of the multi-voltage induction motor at approximately a voltage to frequency design ratio of the multi-voltage induction motor; and
power conductors configured to transmit power to the variable frequency drive at a voltage approximately equal to the second voltage for operation of the multi-voltage induction motor wired in the first voltage wiring configuration.

2. The air conditioning system of claim 1, wherein the multi-voltage induction motor is configured to power the one fan or blower located in a ground support equipment unit for a grounded aircraft.

3. The air conditioning system of claim 2, wherein the multi-voltage induction motor is configured to power a fan adapted to remove heat from a condenser of the refrigeration circuit of the ground support equipment unit.

4. The air conditioning system of claim 2, wherein the multi-voltage induction motor is configured to power a blower configured to circulate air over one or more evaporator coils of the refrigeration circuit of the ground support equipment unit.

5. The air conditioning system of claim 1, wherein the one fan or blower comprises at least one of a centrifugal fan, a positive displacement fan, a centrifugal blower, a positive displacement blower, and a regenerative blower.

6. The air conditioning system of claim 1, wherein the first voltage is equal to approximately 230 volts, and the second voltage is equal to approximately 460 volts.

7. An air conditioning system, comprising:
a refrigeration circuit having at least one fan or blower;
a three phase alternating current (AC) induction motor coupled to the at least one fan or blower and comprising windings configured to be interconnected in a first voltage configuration and a second voltage configuration, the second voltage being greater than the first voltage, wherein the windings are interconnected in the first voltage configuration;
three phase power conductors configured to provide an output voltage equal to approximately the second voltage; and
a variable frequency drive configured to receive power from the three phase power conductors and to control operation of the three phase AC induction motor.

8. The air conditioning system of claim 7, wherein the variable frequency drive is configured to control operation of the three phase AC induction motor by maintaining an operational voltage to frequency ratio of the three phase AC induction motor to a value less than or equal to approximately a voltage to frequency design ratio of the three phase AC induction motor.

9. The air conditioning system of claim 7, wherein the variable frequency drive is configured to control operation of the three phase AC induction motor by increasing a speed of the three phase AC induction motor to a level exceeding a rated speed while maintaining a current design limit of the first voltage configuration.

10. The air conditioning system of claim 7, wherein the variable frequency drive is configured to control operation of the three phase AC induction motor by increasing a speed of the three phase AC induction motor to a level exceeding a rated speed while maintaining a voltage design limit of the first voltage configuration.

11. The air conditioning system of claim 7, wherein the variable frequency drive is configured to control operation of the three phase AC induction motor by increasing a power output of the three phase AC induction motor to a level exceeding a rated power output while maintaining a current design limit and a voltage design limit of the first voltage configuration.

12. The air conditioning system of claim 7, wherein the three phase AC induction motor is configured to provide power for a blower and/or a fan of an aircraft ground support unit.

13. The air conditioning system of claim 12, wherein the refrigeration circuit is associated with a mobile ground support equipment cart for a grounded aircraft.

14. An air conditioning system, comprising:
a refrigeration circuit having at least one fan or blower;
a multi-voltage induction motor coupled to the at least one fan or blower and comprising windings configured to be wired in a first voltage configuration and a second voltage configuration, the second voltage being greater than the first voltage, wherein the windings are wired in the first voltage configuration;
a variable frequency drive coupled to the multi-voltage induction motor and configured to increase an operating speed of the multi-voltage induction motor to a level exceeding a rated speed while maintaining a rated voltage to frequency ratio of the multi-voltage induction motor; and
power conductors configured to provide the variable frequency drive an input voltage equal to approximately the second voltage for operation of the multi-voltage induction motor.

15. The air conditioning system of claim 14, wherein the refrigeration circuit comprises more than one fan or blower, and only one of the fans or blowers receives power from a variable frequency drive.

16. The air conditioning system of claim 15, wherein the at least one fan or blower is associated with the refrigeration circuit located in an aircraft ground support equipment unit.

17. The air conditioning system of claim 14, wherein the variable frequency drive is configured to control operation of the multi-voltage induction motor by increasing a power output of the multi-voltage induction motor to a level exceeding a rated power output while maintaining a current design limit and a voltage design limit of the first voltage configuration.

18. The air conditioning system of claim 14, wherein the first voltage is equal to approximately 230 volts, and the second voltage is equal to approximately 460 volts.

19. The air conditioning system of claim 14, wherein the variable frequency drive is configured to increase the operating speed of the multi-voltage induction motor while maintaining a current rating of the multi-voltage induction motor.

20. The air conditioning system of claim 14, wherein the multi-voltage induction motor is configured to power at least one of a centrifugal fan, a positive displacement fan, a centrifugal blower, a positive displacement blower, and a regenerative blower.
